(19) United States
(12) Patent Application Publication
(10) Pub. No.: US 2008/0148301 A1
(43) Pub. Date: Jun. 19, 2008

(54) Disk Apparatus

(75) Inventors: Kengo Masaoka, Ehime (JP); Shinichi Wada, Ehime (JP)

Correspondence Address: KRATZ, QUINTOS & HANSON, LLP, 1420 K Street, N.W., Suite 400, WASHINGTON, DC, 20005, US

(73) Assignee: MATSUSHITA ELECTRIC INDUSTRIAL CO., LTD.,, Kadoma-shi (JP)

(21) Appl. No.: 11/578,405

(22) PCT Filed: Dec. 24, 2004
(86) PCT No.: PCT/JP04/19733

§ 371 Date: Sep. 5, 2007

(30) Foreign Application Priority Data
Apr. 14, 2004 (JP) 2004-118847

(51) Int. Cl. G11B 17/03

(52) U.S. Cl. 720/601; 720/600

(57) ABSTRACT

An opening 142 into which a rod-like body 200 can be inserted is formed in a front surface of a chassis outer sheath, a temporary gear 202 is provided at a position opposed to the opening 142, a temporary gear 202 and a gear group 62 are connected to each other, and a discharge lever 100 is moved by operation of the rod-like body 200.

### TECHNICAL FIELD

The present invention relates to a disk apparatus for recording or replaying into or from a disk-like recording medium such as a CD and a DVD, and more particularly, to a so-called slot-in type disk apparatus capable of directly inserting or discharging a disk from or to outside.

### BACKGROUND TECHNIQUE

A loading method is widely employed in conventional disk apparatuses. In this method, a disk is placed on a tray or a turntable, and the tray or the turntable is loaded into an apparatus body. However, since the tray or the turntable is required, there is a limit for thinning the disk apparatus body. Therefore, recently, there exist so-called slot-in type disk apparatuses which directly operate disks by a lever or the like by means of a loading motor.

### [Patent document 1]

### Japanese Patent Application Laid-open No. 2002-352498

According to such a slot-in type disk apparatus, it is possible to reduce the disk apparatus body in thickness and size, but since a disk is loaded and unloaded by means of a mechanism which is driven by a loading motor, high priority is given to reduce the thickness, and there is a problem that a disk can not be unloaded when the loading motor is abnormally stopped (power supply is abnormally turned OFF).

According to a conventional technique disclosed in the patent document 1, some contrivance to cope with the problem when the loading motor is abnormally stopped (power supply is abnormally turned OFF) can be found, but much labor is required to unload the disk, and it is difficult to unload the disk easily.

It is an object of the present invention to provide a disk apparatus capable of reducing a disk apparatus in thickness and size, unloading a disk relatively easily even when the loading motor is abnormally stopped (power supply is abnormally turned OFF), and swiftly coping with trouble.

### DISCLOSURE OF THE INVENTION

A first aspect of the present invention provides a disk apparatus comprising a chassis outer sheath having a base body and a lid, in which a front surface of the chassis outer sheath is formed with a disk-inserting opening into which a disk is directly inserted, a connector is disposed on a rear surface of the chassis outer sheath, the base body is provided with a traverse and a printed substrate, the traverse holds a spindle motor, a pickup and drive means for moving the pickup, the traverse is disposed on the side of the disk inserting opening, and the printed substrate is disposed on the side of the connector, the disk apparatus includes traverse moving means for displacing the traverse such that the spindle motor supported by the traverse can move between the base body and the lid, the traverse moving means comprises a loading motor provided near a front surface of the chassis outer sheath, a slider which is connected to a drive shaft of the loading motor through a gear group and which slides in a longitudinal direction by driving force of the loading motor, and a cam mechanism provided on the slider, the base body is provided with a discharge lever which pushes out a disk inserted on the traverse toward the disk inserting opening, and the disk apparatus includes a discharging driving mechanism which moves the discharge lever by motion of the slider caused by driving force of the loading motor, wherein an opening into which a rod-like body can be inserted is formed in the front surface of the chassis outer sheath, a temporary gear is provided at a position opposed to the opening, the temporary gear and the gear group are connected to each other, and the discharge lever is moved by operation of the rod-like body.

According to this aspect, the temporary gear can be operated from the front surface. Since a disk can be discharged by moving the discharge lever by the operation of the temporary gear, the disk can be unloaded also when the loading motor is abnormally stopped.

According to a second aspect of the invention, in the disk apparatus of the first aspect, the temporary gear is held by an elastic member, and the elastic member is deformed by a pressing operation by the rod-like body against the temporary gear, thereby connecting the temporary gear and the gear group to each other.

According to this aspect, the temporary gear does not move in a normal motion, and the temporary gear can be connected to the gear group only when the rod-like body is operated. Thus, a load at the time of normal motion can be reduced.

According to a third aspect of the invention, in the disk apparatus of the first aspect, a gear connected to the drive shaft of the loading motor is formed with a bevel gear, and the temporary gear is connected to the bevel gear.

According to this aspect, the temporary gear can be disposed near the front surface.

According to a fourth aspect of the invention, in the disk apparatus of the third aspect, the temporary gear and the bevel gear are previously connected to each other.

According to this aspect, it is unnecessary to provide a space for displacing the temporary gear, and the temporary gear can be provided in a limited space.

A fifth aspect of the invention provides a disk apparatus comprising a chassis outer sheath having a base body and a lid, in which a front surface of the chassis outer sheath is formed with a disk inserting opening into which a disk is directly inserted, a connector is disposed on a rear surface of the chassis outer sheath, the base body is provided with a traverse and a printed substrate, the traverse holds a spindle motor, a pickup and drive means for moving the pickup, the traverse is disposed on the side of the disk inserting opening, and the printed substrate is disposed on the side of the connector, the disk apparatus includes traverse moving means for displacing the traverse such that the spindle motor supported by the traverse can move between the base body and the lid, the traverse moving means comprises a loading motor provided near a front surface of the chassis outer sheath, a slider which is connected to a drive shaft of the loading motor through a gear group and which slides in a longitudinal direction by driving force of the loading motor, and a cam mechanism provided on the slider, the base body is provided with a discharge lever which pushes out a disk inserted on the traverse toward the disk inserting opening, and the disk apparatus includes a discharging driving mechanism which moves the discharge lever by motion of the slider caused by driving force of the loading motor, wherein an opening into which a rod-like body can be inserted is formed in the front surface of the chassis outer sheath, the slider or the discharge slider is allowed to slide by operation of the rod-like body from the opening, and the discharge lever is moved without a driving force from the loading motor.

According to this aspect, a disk can be discharged by operation from the front surface.

According to a sixth aspect of the invention, in the disk apparatus of the fifth aspect, the discharge slider is disposed at a position opposed to the opening, and an operation direction of the rod-like body from the opening and an operation direction at the time of discharging operation of the discharging slider match with each other.

According to this aspect, since the discharging slider can directly be operated, a disk can be discharged without adding a part for discharging the disk.

According to a seventh aspect of the invention, in the disk apparatus of the fifth aspect, a temporary slider is disposed at a position opposed to the opening, the slider slides by sliding motion of the temporary slider, an operation direction of the rod-like body from the opening and an operation direction of the temporary slider match with each other, and the temporary slider is allowed to slide by operation of the rod-like body.

According to this aspect, the slider can be moved by the temporary slider and the discharge lever can be moved by the pushing the temporary slider. Therefore, the discharging operation can be carried out easily.

According to an eighth aspect of the invention, the disk apparatus of the fifth aspect further comprises connection-releasing means which releases connection between the loading motor and the slider.

According to this aspect, since the connection between the loading motor and the slider can be released prior to the operation of the rod-like body, the discharging operation can be carried out easily.

According to a ninth aspect of the invention, in the disk apparatus of the first or fifth aspect, the traverse is displaced by the traverse moving means before the discharge lever is moved, and a held state of the disk to the spindle motor is released by the displacement of the traverse.

According to this aspect, even a disk which is in a chucking state can be taken out easily.

### BRIEF DESCRIPTION OF THE DRAWINGS

FIG. 1 is a plan view of a base body of a disk apparatus according to an embodiment of the present invention;

FIG. 2 is a plan view of an essential portion of the disk apparatus;

FIG. 3 is a plan view of a lid of the disk apparatus;

FIG. 4 is a front view of a bezel mounted on a front surface of a chassis outer sheath of the disk apparatus;

FIG. 5 is a plan view of the base body of the disk apparatus showing an initial stage of a disk inserting operation of the embodiment;

FIG. 6 is a plan view of the base body of the disk apparatus showing an intermediate stage of the disk inserting operation of the embodiment;

FIG. 7 is a plan view of the base body of the disk apparatus showing a completed stage of the disk inserting operation of the embodiment;

FIG. 8 is a plan view of the base body of the disk apparatus showing a stage after a predetermined time is elapsed from the state shown in FIG. 7;

FIG. 9 is a plan view of the base body of the disk apparatus showing a state in which a traverse is operated in a direction where a spindle motor side comes closest to the lid;

FIG. 10 is a side view of a main slider showing a first cam mechanism of the embodiment;

FIG. 11 is a side view of a sub-slider showing a second cam mechanism and a third cam mechanism of the embodiment;

FIG. 12 is a front view of a front surface of a chassis outer sheath of a disk apparatus according to another embodiment of the invention;

FIG. 13 is a plan view of an essential portion of a base body of a disk apparatus according to the embodiment;

FIG. 14 is a plan view of the essential portion of the base body of the disk apparatus according to the embodiment;

FIG. 15 is a plan view of the essential portion of the base body of the disk apparatus according to the embodiment;

FIG. 16 is a plan view of an essential portion of a disk apparatus according to another embodiment;

FIG. 17 is a plan view of an essential portion of a base body of a disk apparatus according to another embodiment; and

FIG. 18 is a plan view of an essential portion of another state of the base body of the disk apparatus of the embodiment.

### BEST MODE FOR CARRYING OUT THE INVENTION

### First Embodiment

A disk apparatus according to an embodiment of the present invention will be explained.

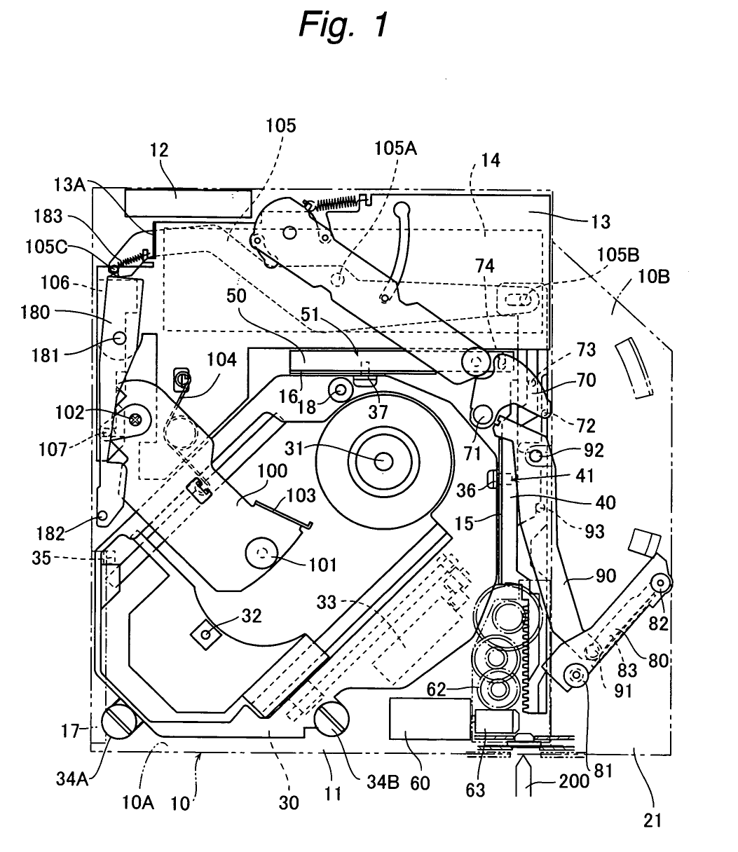

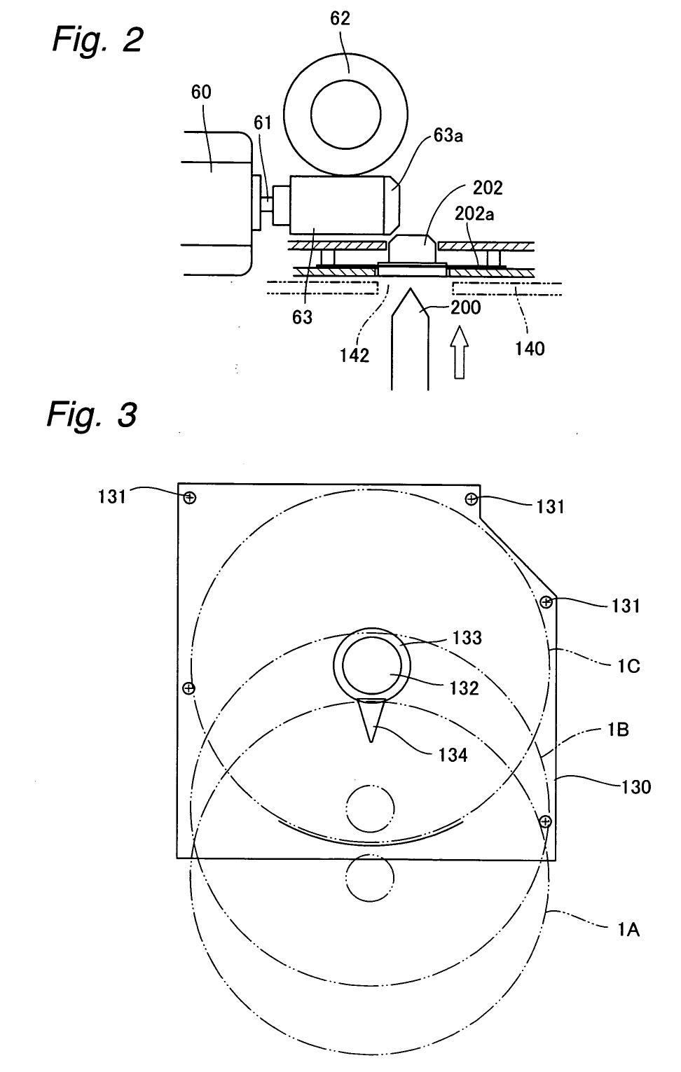

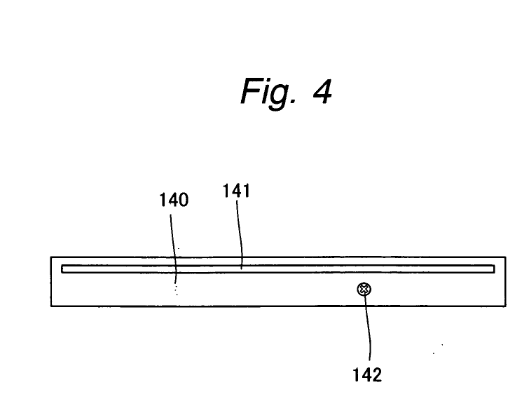

FIG. 1 is a plan view of a base body of a disk apparatus according to an embodiment of the present invention. FIG. 2 is a plan view of an essential portion of the disk apparatus. FIG. 3 is a plan view of a lid of the disk apparatus. FIG. 4 is a front view of a bezel mounted on a front surface of a chassis outer sheath of the disk apparatus.

The disk apparatus of the embodiment comprises a chassis outer sheath having a base body and a lid. A bezel is mounted on a front surface of the chassis outer sheath. The disk apparatus of the embodiment is of a slot-in type in which a disk is directly inserted into the disk apparatus from a disk inserting opening formed in the bezel shown in FIG. 3.

As shown in FIG. 1, various parts having function for recording or replaying into or from a disk, and a function for loading the disk are mounted on the base body 10.

The base body 10 is formed with a deep portion 10A and a shallow portion 10B with respect to the lid. A wing portion extending from a front surface to a rear surface is formed by the shallow portion 10B.

A disk inserting opening 11 into which a disk is directly inserted is formed in a front surface of the base body 10. A connector 12 is disposed on an end of a rear surface of the base body 10. A traverse 30 is disposed on the base body 10 on the side of the disk inserting opening 11, and a rear base 13 is disposed on the base body 10 on the side of the connector 12. The traverse 30 and the rear base 13 are not superposed on each other. A printed substrate 14 is disposed on the rear base 13 on the side of the surface of the base body 10.

The traverse 30 holds a spindle motor 31, a pickup 32 and drive means 33 for moving the pickup 32. The spindle motor 31 is provided on the side of one end of the traverse 30, and the pickup 32 is provided such that it can move from the one end side to the other end side of the traverse 30. When the pickup 32 is stopped, it is disposed on the other end side of the traverse 30.

The drive means 33 includes a drive motor, a pair of rails on which the pickup 32 slides, and a gear mechanism for transmitting a driving power of the drive motor to the pickup 32. The pair of rails are disposed on both sides so that the one end side and the other end side of the traverse 30 are connected to each other. The drive motor is disposed outside of the rail on the side of the disk inserting opening 11 such that a drive shaft and the rails are in parallel to each other. The gear mechanism is disposed in a space between the drive motor and the rail on the side of the disk inserting opening 11.

The spindle motor 31 of the traverse 30 is located at a central portion of the base body 10, a reciprocating range of the pickup 32 is located closer to the disk inserting opening 11 than the spindle motor 31, and a reciprocating direction of the pickup 32 is different from an inserting direction of the disk. An angle formed between the reciprocating direction of the pickup 32 and the inserting direction is in a range of 40° to 45°.

The traverse 30 is supported by the base body 10 by means of a pair of insulators 34A and 34B.

It is preferable that the pair of insulators 34A and 34B are disposed close to a stationary position of the pickup 32 than the position of the spindle motor 31, and are disposed closer to the disk inserting opening 11 than the stationary position of the pickup 32. In this embodiment, the insulator 34A is provided on one end side of the disk inserting opening 11 near its inner side, and the insulator 34B is provided on the central portion of the disk inserting opening 11 near the inner side thereof. The insulators 34A and 34B include damper mechanisms made of elastic material. The insulators 34A and 34B can be displaced by the damper mechanism in a direction in which the traverse 30 is separated from the base body 10.

A rib 35 is provided on a surface of the traverse 30 on the side of the base body 10. The rib 35 is provided on the side of the stationary position of the pickup 32 outside of the rail opposite from the disk inserting opening 11. The rib 35 has such an enough height that when the traverse 30 approaches the base body 10, the traverse 30 abuts against the base body 10, the traverse 30 can be displaced in a direction where the traverse 30 is separated from the base body 10 at the positions of the insulators 34A and 34B. Although the rib 35 is provided on the surface of the traverse 30 on the side of the base body 10 in this embodiment, the rib 35 may be provided on the surface of the base body 10 on the side of the traverse 30. Ribs 35 may be provided on the surfaces of the traverse 30 both on the side of the base body 10 and on the side of the traverse 30. Although the traverse 30 on the side of the insulators 34A and 34B are moved upward utilizing the approaching motion of the traverse 30 toward the base body 10 in the embodiment, this can be realized by other means which changes the height of the traverse 30 at the positions of the insulators 34A and 34B, e.g., means which changes heights of the insulators 34A and 34B.

The traverse 30 is operated in such a manner that the spindle motor 31 approaches or separates from the base body 10 around the insulators 34A and 34B as fulcrums.

A main slider 40 and a sub-slider 50 having cam mechanisms which operate the traverse 30 will be explained below.

Each of the main slider 40 and the sub-slider 50 has the cam mechanism which displaces the traverse 30. The main slider 40 and the sub-slider 50 are located on the side of the spindle motor 31. The main slider 40 is disposed such that one end thereof is located on the side of a front surface of a chassis body 10 and the other end of the main slider 40 is located on the side of a rear surface of the chassis body 10. The sub-slider 50 is disposed between the traverse 30 and the rear base 13 in a direction perpendicular to the main slider 40.

The cam mechanisms which displace the traverse 30 comprise a first cam mechanism 41 and a second cam mechanism 51. The first cam mechanism 41 is provided on a surface of the main slider 40 on the side of the spindle motor 31, and the second cam mechanism 51 is provided on a surface of the sub-slider 50 on the side of the spindle motor 31.

A base member 15 is provided between the main slider 40 and the traverse 30, and a base member 16 is provided between the sub-slider 50 and the traverse 30. The base member 15 and the base member 16 are fixed to the base body 10, the base member 15 and the base member 16 limit a position of a cam pin 36 of the traverse 30 by a vertical groove formed in the base member 15, and limit a position of a cam pin 37 of the traverse 30 by a vertical groove formed in the base member 16.

Here, the base member 16 and the sub-slider 50 are connected to each other through a third cam mechanism (not shown in FIG. 1). The third cam mechanism has a function for moving the sub-slider 50 in a direction separating away from the base body 10 when the traverse 30 is moved in a direction separating away from the base body 10 by the second cam mechanism 51.

A loading motor 60 is disposed on the side of one end of the main slider 40. The loading motor 60 and the one end of the main slider 40 are connected to each other through a gear mechanism.

FIG. 2 is a plan view around the loading motor 60.

A gear 63 is provided on the drive shaft 61 of the loading motor 60, and a worm gear cluster 62 meshes the gear 63. They constitute a gear group of the present invention. A bevel gear 63a is formed on a tip end of the gear 63 which meshes the worm gear cluster 62. As shown in FIG. 4, an opening 142 is formed in a front surface of the chassis outer sheath or the bezel 140. A rod-like body 200 can be inserted into the opening 142.

As shown in FIG. 2, if the rod-like body 200 is inserted from the opening 142, a leaf spring 202a can be deformed, and a temporary gear 202 can mesh the bevel gear 63a. If the rod-like body 200 is turned in a state where the temporary gear 202 meshes the bevel gear 63a, the gear 63 and the worm gear cluster 62 can be rotated.

The loading motor 60 is disposed such that its body is located in the central portion of the disk inserting opening 11, and the drive shaft 61 is located on the side of the end of the disk inserting opening 11.

The main slider 40 can slide in the longitudinal direction by operating the loading motor 60. The main slider 40 is connected to the sub-slider 50 by a cam lever 70.

The cam lever 70 has a turning fulcrum 71. The cam lever 70 engages a cam groove formed in an upper surface of the main slider 40 by pins 72 and 73, and engages a cam groove formed in an upper surface of the sub-slider 50 by a pin 74.

The cam lever 70 moves the sub-slider 50 at timing at which the traverse 30 is displaced by the first cam mechanism 41 of the main slider 40, operates the second cam mechanism 51 by movement of the sub-slider 50, and displaces the traverse 30.

The above-explained connector 12, traverse 30, rear base 13, printed substrate 14, insulators 34A and 34B, main slider 40, sub-slider 50, base member 15, base member 16 and loading motor 60 are formed in the deep portion 10A of the base body 10, and a disk-inserting space is formed between the lid and these members.

Next, a guide member which supports a disk when the disk is inserted, and a lever member operated when the disk is inserted will be explained.

A first disk guide 17 having a predetermined length is provided on one end side of the deep portion 10A near the disk inserting opening 11. The first disk guide 17 has a groove whose cross section as viewed from a disk-inserting side is of U-shape. A disk is supported by this groove.

A pull-in lever 80 is provided in the base body 10 on the other end side of the disk inserting opening 11. A second disk guide 81 is provided on a movable side end of the pull-in lever 80. The second disk guide 81 comprises a cylindrical roller, and is turnably provided on the movable side end of the pull-in lever 80. A groove is formed in a roller outer periphery of the second disk guide 81, and a disk is supported by this groove.

The pull-in lever 80 is disposed such that its movable side end is operated on the side of the disk inserting opening 11 than its stationary side end, and the pull-in lever 80 is provided at its stationary side end with a turning fulcrum 82.

A long groove 83 is formed between the movable side end and the stationary side end of a back surface of the pull-in lever 80 (surface on the side of the base body 10). A third disk guide 84 having a predetermined length is provided between the movable side end and the stationary side end of the surface of the pull-in lever 80.

The pull-in lever 80 is operated by a sub-lever 90.

The sub-lever 90 is provided at its movable side one end with a projection 91, and at its other end with a turning fulcrum 92. The projection 91 of the sub-lever 90 slides in the long groove 83 of the pull-in lever 80. The turning fulcrum 92 of the sub-lever 90 is located on the main slider 40. The turning fulcrum 92 does not move in association with the main slider 40, and is fixed to the base body 10 through the base member 15. A pin 93 is provided on a lower surface of the sub-lever 90 closer to the projection 91 than the turning fulcrum 92. The pin 93 slides in a cam groove formed in an upper surface of the main slider 40. Therefore, an angle of the sub-lever 90 is changed as the main slider 40 moves, and by changing the angle of the sub-lever 90, the turning angle of the pull-in lever 80 is changed. That is, the second disk guide 81 of the pull-in lever 80 approaches and separates from the spindle motor 31 by operating the sub-lever 90. The groove 83A extending in the turning direction of the sub-lever 90 is formed in an end of the long groove 83 close to the movable side end of the pull-in lever 80. Even if the turning angle of the sub-lever 90 is varied when the second disk guide 81 pulls a disk to the deepest position by the groove 83A, the turning angle of the pull-in lever 80 is not varied, and the pull-in amount of the disk can be stabilized.

A discharge lever 100 is provided on a side portion of the base body 10 which is different from the pull-in lever 80. A guide 101 is provided on a movable side end of one end side of the discharge lever 100. A turning fulcrum 102 is provided on the other end side of the discharge lever 100. An abutting portion 103 is provided on the movable side end of the discharge lever 100 closer to a rear surface thereof than the guide 101. An elastic body 104 is provided on the discharge lever 100. One end of the elastic body 104 is fixed to the discharge lever 100 and the other end thereof is fixed to the rear base 13. When the abutting portion 103 is pulled toward the rear surface by the elastic body 104, the abutting portion 103 abuts against an abutting portion 13A of the rear base 13. The discharge lever 100 is pulled out toward the disk inserting opening 11 by an elastic force of the elastic body 104. The discharge lever 100 is operated in association with motion of the main slider 40 through the link arm 105 and the discharge slider 106. The link arm 105 is turnably mounted on the rear base 13 by the shaft 105A, one end side of the link arm 105 is connected to the main slider 40 through a pin 105B, and the other end of the link arm 105 is connected to a discharge slider 106 by a pin 105C. The discharge lever 100 engages a cam groove in the discharge slider 106 by a cam pin 107.

A restriction lever 110 is provided on the side of the rear surface of the base body 10. An end of the restriction lever 110 on the side of the rear surface is a turning fulcrum 111, and its movable side end has a guide 112. A portion of the restriction lever 110 on the side of the guide 112 is always biased to project toward the front surface by an elastic body 113. The restriction lever 110 operates a limit switch at a predetermined position. That is, if a disk is inserted to a predetermined position, the limit switch is turned off and the loading motor 60 is operated. By the rotation of the loading motor 60, the main slider 40 slides.

A guide lever 180 is provided on a side of the base body 10 on the same side as the discharge lever 100. A rear surface side of the guide lever 180 is a turning fulcrum 181, and a guide 182 is provided on a movable side of the guide lever 180. The guide lever 180 is biased such that a portion thereof on the side of the guide 182 is projects toward a disk by an elastic body 183. The guide lever 180 moves in association with the main slider 40 through the link arm 105 and the discharge slider 106, and a portion of the guide lever 180 on the side of the guide 182 separates from the disk in accordance with the motion of the main slider 40.

A protect mechanism 120 is provided inside of the disk inserting opening 11. When a disk is already set in the chassis outer sheath, the protect mechanism 120 prevents another disk from being inserted from the disk inserting opening 11. The traverse 30 near the spindle motor 31 includes an opening, and a pin 18 projecting from the base body 10 toward the lid is provided in the opening. In a state where the traverse 30 moves closest to the base body 10, the pin 18 has a height projecting toward the lid than the hub of the spindle motor 31, and in a driving state of the spindle motor 31 (operating state where it is possible to replay and record), the pin 18 has a height pulled toward the base body 10 than the hub of the spindle motor 31. It is preferable that that pin 18 is located at a position corresponding to a non-recording surface of a center portion of a disk which is set on the spindle motor 31, and at a position further from the insulator 34 than the spindle motor 31.

Next, the lid of the disk apparatus will be explained using FIG. 3.

A plurality of screw holes 131 are provided in an outer edge of the lid 130. The lid 130 is mounted on the base body 10 by means of screws.

The lid 130 is formed at its central portion with an opening 132. The opening 132 is a circular opening having a radius greater than that of the center hole of the disk. Therefore, the opening 132 is greater than the hub of the spindle motor 31 which is fitted into the central hole of the disk.

A narrowed portion 133 projecting toward the base body 10 is formed on an outer peripheral portion of the opening 132. The opening 132 is provided with a narrowed portion 134 which is tapered from the narrowed portion 133 toward the disk inserting opening 11. A projecting guide is formed on the side of the base body 10 by the narrowed portion 134.

Next, the bezel will be explained using FIG. 4.

The bezel 140 is provided with an insertion port 141. The insertion port 141 is formed such that its central portion has the greatest width and the width is gradually reduced toward its both ends. An opening 142 is formed in the bezel 140 at its location opposed to the temporary gear 202.

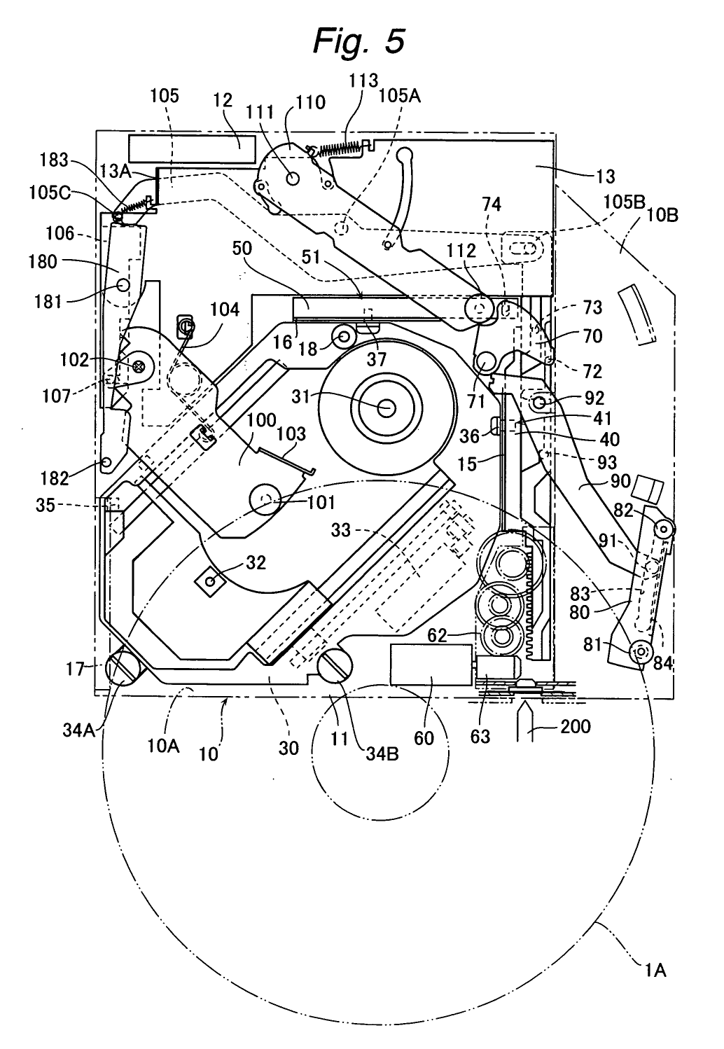

Motions of various members when a disk is inserted will be explained using FIGS. 5 to 11.

FIG. 5 is a plan view of the base body of the disk apparatus showing an initial stage of a disk inserting operation, and shows a state of the disk 1A shown in FIG. 3.

When the disk 1 is not inserted, the pull-in lever 80 is in a standby state where the pull-in lever 80 is turned toward the spindle motor 31 through a predetermined angle. In this state, the projection 91 of the sub-lever 90 is located at the movable side end of the long groove 83 before the groove 83A. A distance between the guide 17 and the second disk guide 81 is smaller than a diameter of the disk 1.

In the initial state when the disk 1 is to be inserted, the disk 1A is first abuts against the guide 17 and the second disk guide 81, the disk 1A is supported by the guide 17 and the second disk guide 81 and its position is restricted.

If the disk 1A is further pushed in, the second disk guide 81 is turned in a direction away from the spindle motor 31 together with the inserting motion. With this turning motion of the second disk guide 81, the projection 91 of the sub-lever 90 slides in the long groove 83 toward the stationary side end. Therefore, the sub-lever 90 also turns around the turning fulcrum. If the disk 1A is further inserted, the disk 1A abuts against the guide 101 of the discharge lever 100. FIG. 5 shows this state.

In the state shown in FIG. 5, the loading motor 60 is not operated and thus, the main slider 40 and the sub-slider 50 are not operated either.

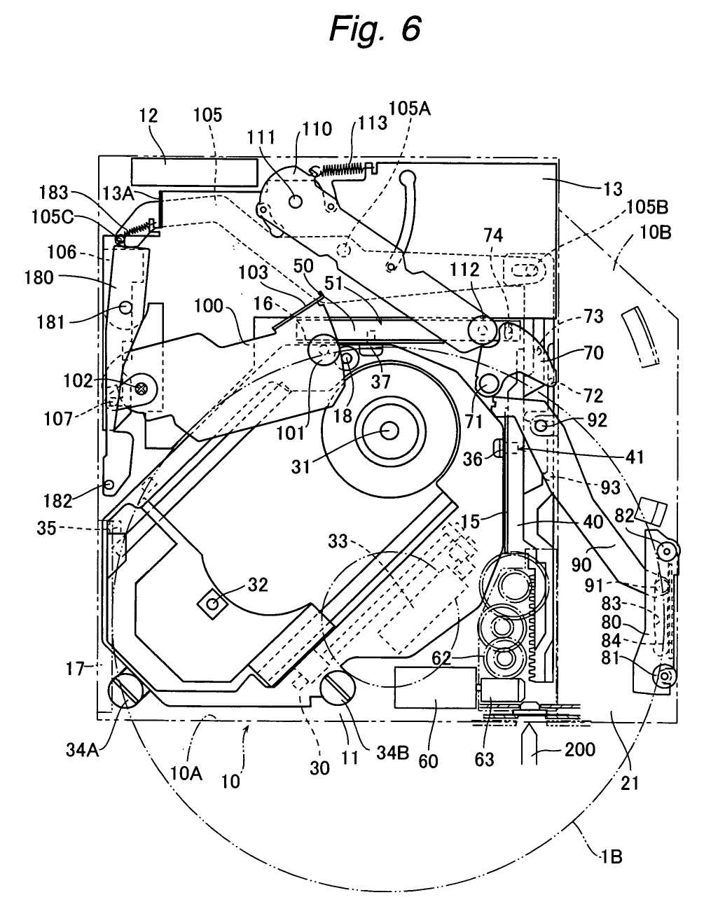

FIG. 6 is a plan view of the base body of the disk apparatus showing an intermediate stage of the disk inserting operation, and shows a state of a disk 1B shown in FIG. 3.

If the disk 1 is further inserted from the state shown in FIG. 5, one end of the disk is supported by the guide 17 and in this state, the other end thereof is supported by the third disk guide 84. The pull-in lever 80 is most separated from the spindle motor 31 in this state. In this state, the projection 91 of the sub-lever 90 is located at the stationary side end of the long groove 83. A distance between the guide 17 and the second disk guide 81 is substantially the same as a diameter of the disk 1. Since the guide 101 is pushed by the disk 1B, the discharge lever 100 keeps turning together with the inserting motion of the disk.

If the disk 1B is further pushed in from the state shown in FIG. 6, the second disk guide 81 moves toward the spindle motor 31 together with the inserting motion. As the second disk guide 81 turns, the projection 91 of the sub-lever 90 slides in the long groove 83 from the stationary side end toward the movable side end. Therefore, the sub-lever 90 also turns around the turning fulcrum 92.

In the above motion process, the disk 1B abuts against the guide 112 of the restriction lever 110, and the restriction lever 110 turns.

When the second disk guide 81 turns toward the spindle motor 31 through a predetermined angle, the restriction lever 110 also turns through a predetermined angle by the disk 1B. If the restriction lever 110 turns through the predetermined angle, the limit switch is operated, and the loading motor 60 starts rotating. The guide 182 of the guide lever 180 projects toward the disk 1B, and the disk 1B is supported also by the guide 182 and slides.

The main slider 40 starts sliding toward the rear surface by the rotation of the loading motor 60. By the motion of the main slider 40, the pin 93 of the sub-lever 90 moves along the cam groove provided in the corresponding main slider 40. At that time, the pin 93 moves toward the spindle motor 31 by the corresponding cam groove. By the movement of the pin 93, the sub-lever 90 biases the pull-in lever 80 in a direction in which the movable side end thereof turns and moves toward the spindle motor 31. Therefore, the pull-in lever 80 biases the disk 1B in the inserting direction. By this biasing force of the pull-in lever 80, the disk is further pushed in without manual operation.

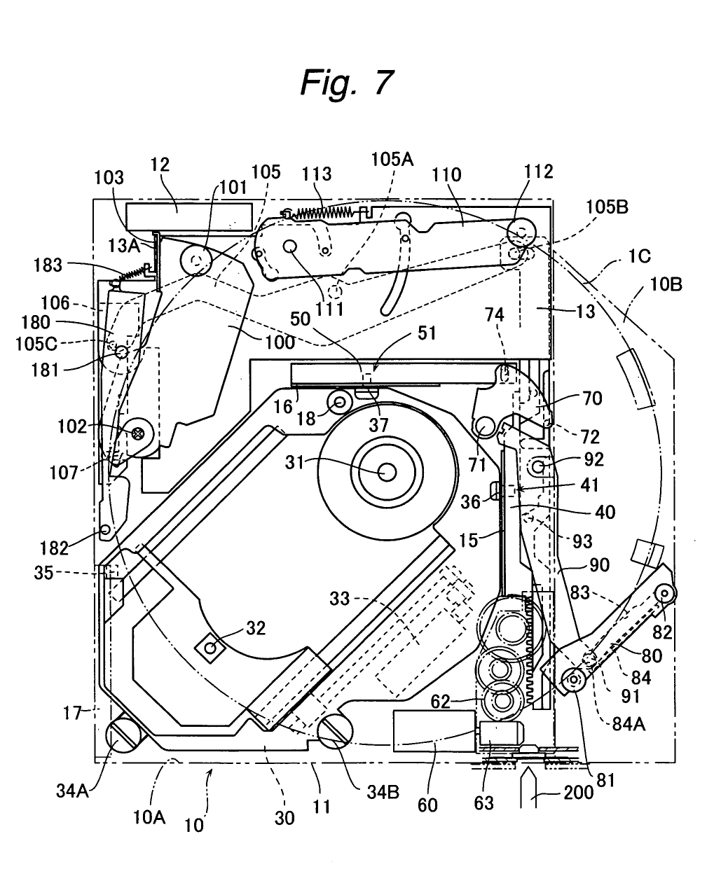

FIG. 7 is a plan view of the base body of the disk apparatus showing a completed stage of the disk inserting operation, and shows a state of a disk 1C shown in FIG. 3.

The disk 1C is supported by three points, i.e., the second disk guide 81, the guide 182 of the guide lever 180 and the guide 112 of the restriction lever 110, and a center hole of the disk 1C is restricted to a position corresponding to the spindle motor 31.

The loading motor 60 keeps rotating, and the main slider 40 also keeps sliding.

The main slider 40 moves for a predetermined time from the state shown in FIG. 7, but since the cam groove corresponding to the pin 93 of the sub-lever 90 is in parallel to the moving direction, the sub-lever 90 is not operated. In this state, the projection 91 of the sub-lever 90 is located in the groove 83A. The pull-in lever 80 is not operated, and the state where the disk 1C is supported is maintained.

The cam lever 70 is not yet operated for a predetermined time from the state shown in FIG. 7. That is, cam grooves corresponding to the pins 72 and 73 of the cam lever 70 are formed in parallel to the moving direction of the main slider 40.

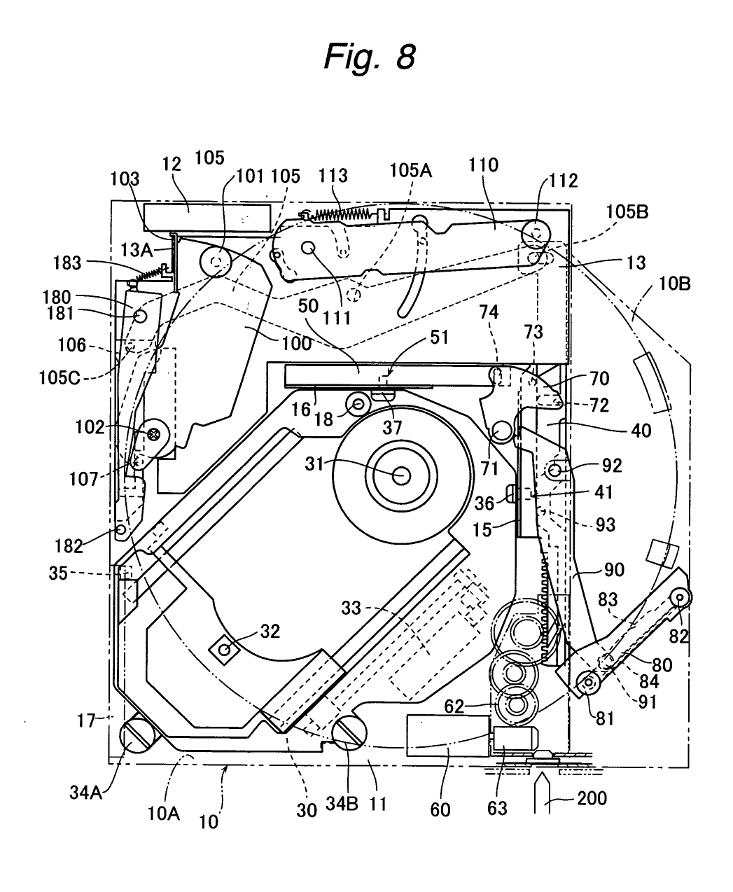

FIG. 8 is a plan view of the base body of the disk apparatus showing a stage after a predetermined time is elapsed from the state shown in FIG. 7.

The motion of the traverse 30 starts from the state shown in FIG. 8. That is, the traverse 30 starts its motion in a direction in which the side of the spindle motor 31 approaches the lid 130.

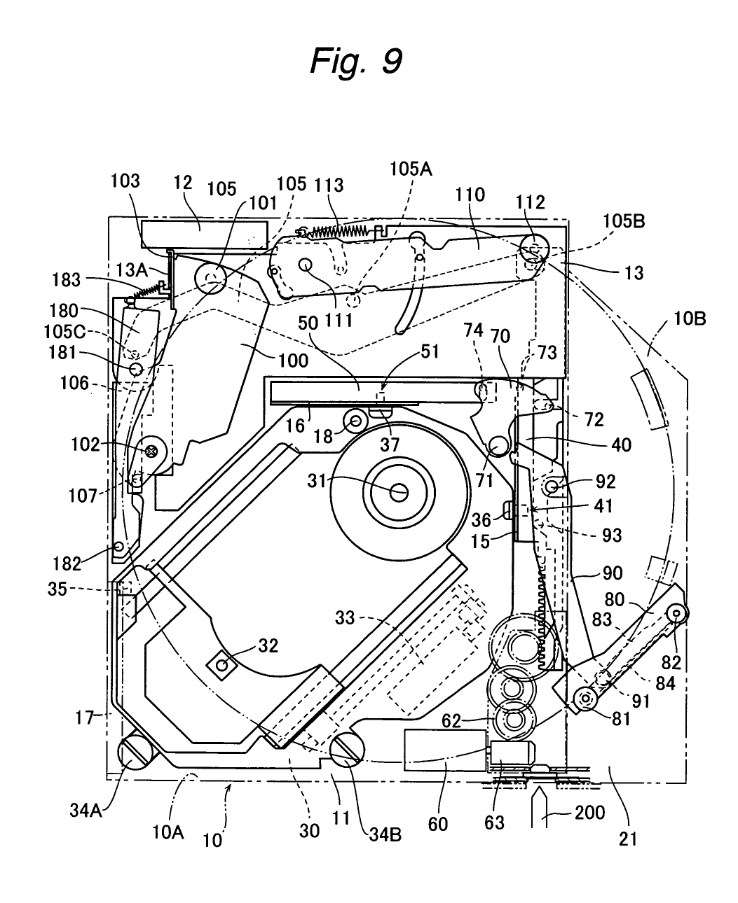

A motion mechanism of the traverse 30 will be explained using FIGS. 9 to 11.

FIG. 9 is a plan view of the base body of the disk apparatus showing a state in which the traverse 30 is operated in a direction where the side of the spindle motor 31 comes closest to the lid 130.

If the loading motor 60 is operated to move the main slider 40 from the state shown in FIG. 8, the cam lever 70 turns around the turning fulcrum 71 by the pin 72. By the turning motion of the cam lever 70, the sub-slider 50 slides in a direction away from the main slider 40.

The traverse 30 is operated by the sliding motions of the main slider 40 and the sub-slider 50 from the state shown in FIG. 8. The pull-in lever 80 keeps holding the disk 1C.

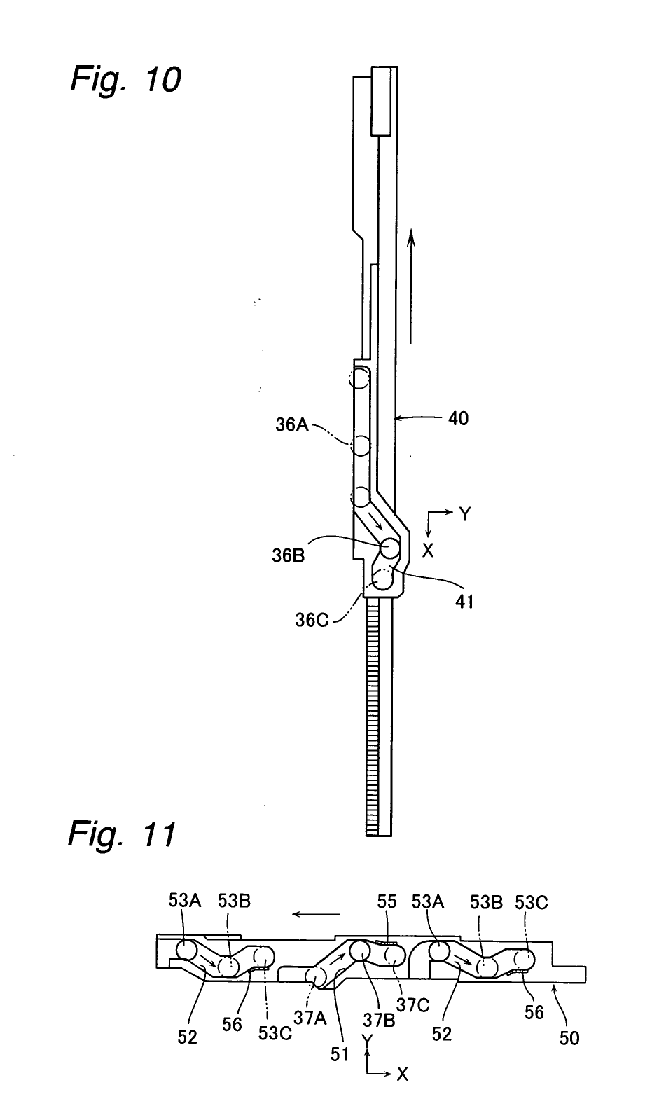

FIG. 10 is a side view of the main slider showing a first cam mechanism. FIG. 11 is a side view of the sub-slider showing a second cam mechanism and a third cam mechanism.

As shown in FIG. 10, the main slider 40 is provided with a long groove constituting the first cam mechanism 41. The cam pin 36 fixed to the traverse 30 is slidably provided in the long groove. The first cam mechanism 41 comprises the long groove and the cam pin 36.

As shown in FIG. 11, the sub-slider 50 is provided with a long groove constituting the second cam mechanism 51. The cam pin 37 fixed to the traverse 30 is provided with the long groove. The second cam mechanism 51 comprises the long groove and the cam pin 37. The sub-slider 50 is provided at its both ends with two long grooves which constitute third cam mechanism 52 and which have the same shapes. A cam pin 53 fixed to the base member 16 is slidably provided in each of the long grooves. The third cam mechanism 52 comprises the long grooves and the cam pins 53.

A cam pin 36A in FIG. 10 and cam pins 37A and 53A in FIG. 11 show a state of the FIG. 8 before the traverse 30 is operated.

A cam pin 36B in FIG. 10 and cam pins 37B and 53B in FIG. 11 show a state shown in FIG. 9 in which the traverse 30 is moved in a direction where the spindle motor 31 side comes closest to the lid 130.

Arrows in FIGS. 10 and 11 show moving directions of the main slider 40 and the sub-slider 50, respectively.

As shown in FIG. 10, the cam pin 36 moves from the position of the cam pin 36A to the position of the cam pin 36B, thereby operating the traverse 30. Therefore, in the position of the cam pin 36 of the traverse 30, the traverse 30 moves from the position of the cam pin 36A to the position of the cam pin 36B with respect to the base body 10 by a moving distance in the Y axis direction.

As shown in FIG. 11, the cam pin 37 moves from the position of the cam pin 37A to the position of the cam pin 37B, thereby operating the traverse 30 with respect to the sub-slider 50. Therefore, in the position of the cam pin 36 of the traverse 30, the traverse 30 moves from the position of the cam pin 36A to the position of the cam pin 36B with respect to the sub-slider 50 by the moving distance in the Y axis direction. The cam pin 53 moves from the position of the cam pin 53A to the position of the cam pin 53B, thereby operating the sub-slider 50 with respect to the base body 10. Therefore, in the position of the cam pin 36 of the traverse 30, the sub-slider 50 moves from the position of the cam pin 53A to the position of the cam pin 53B with respect to the base body 10 by the moving distance in the Y axis direction. On the side of the sub-slider 50, the traverse 30 moves in the Y axis direction with respect to the base body 10 by a total moving distance of the moving distance in the Y axis direction from the position of the cam pin 36A to the position of the cam pin 36B and the moving distance in the Y axis direction from the position of the cam pin 53A to the position of the cam pin 53B.

In the embodiment, the moving distance in the Y axis direction from the from the position of the cam pin 36A to the position of the cam pin 36B shown in FIG. 10 is the same as a total moving distance of the moving distance in the Y axis direction from the position of the cam pin 37A to the position of the cam pin 37B shown in FIG. 11 and the moving distance in the Y axis direction from the position of the cam pin 53A to the position of the cam pin 53B.

In the state where the apparatus is operated in the above manner and the spindle motor 31 side of the traverse 30 comes closest to the lid 130, the disk 1 abuts against the lid 130 and is pressed by the spindle motor 31 and the lid 130. By this pressing force, the hub 31B of the spindle motor 31 is fitted to the center hole of the disk 1, and the chucking operation is completed.

If the chucking operation is completed, the spindle motor 31 side of the traverse 30 separates from the lid 130.

This motion is carried out by further rotating the loading motor 60 to move the main slider 40.

The motion from the completion of the chucking operation to the operation state in which the spindle motor 31 can replay and record (driving state) is carried out by moving the cam pin 36 from the position of the cam pin 36B to the position of the cam pin 36C in the main slider 40, and by moving the cam pin 37 from the position of the cam pin 37B to the position of the cam pin 37C, and by moving the cam pin 53 from the position of the cam pin 53B to the position of the cam pin 53C in the sub-slider 50.

When the spindle motor 31 is in an operative state (driving state) where the spindle motor 31 can replay and record, the support of the disk 1 by the second disk guide 81 of the pull-in lever 80, the guide 101 of the restriction lever and the guide 182 of the guide lever 180, and the disk 1 is held only by the hub of the spindle motor 31. The second disk guide 81 of the pull-in lever 80, the guide 101 of the restriction lever and the guide 182 of the guide lever 180 are operated by the moving motion

As shown in FIG. 11, the second cam mechanism 51 of the sub-slider 50 is provided with an elastic body 55 comprising a leaf spring for example, and the third cam mechanism 52 is provided with an elastic body 56 comprising a leaf spring for example. The elastic body 55 and the elastic body 56 are provided such that a biasing direction of the elastic body 55 against the cam pin 37 and a biasing direction of the elastic body 56 against the cam pin 53 are different. It is preferable that the biasing directions of the elastic body 55 and the elastic body 56 are opposite from each other.

When the set disk 1 is discharged, the loading motor 60 is rotated, to move the main slider 40. Basically, the above procedure is carried out reversely.

The operation required until the set disk is discharged will be explained briefly.

First, based on an ejection command, the loading motor 60 is rotated, and the main slider 40 moves toward the disk inserting opening 11.

Therefore, in the main slider 40, the cam pin 36 moves from the position of the cam pin 36C to the position of the cam pin 36A through the position of the cam pin 36B. In the sub-slider 50, the cam pin 37 moves from the position of the cam pin 37C to the position of the cam pin 37A through the position of the cam pin 37B, and the cam pin 53 moves from the cam pin 53C to the cam pin 53A through the position of the cam pin 53B.

If the cam mechanisms are moved, the disk 1 once moves toward the lid 130 and then moves toward the base body 10.

When the disk 1 moves toward the base body 10, the disk 1 abuts against the second disk guide 81, the guides 181 and 112 on the side of the outer periphery of the disk 1, and abuts against the pin 18 on the side of the inner periphery of the disk 1. Therefore, as the traverse 30 moves toward the base body 10, a force acting toward the lid 130 is applied to the disk 1 from the second disk guide 81, the guides 101 and 112 and the pin 18, and the disk 1 is released from the hub of the spindle motor 31. If the pin 18 is provided at the position of the outer periphery of the spindle motor 31 and further from the insulator 34 than the spindle motor 31 as in this embodiment, the disk 1 can be released from the hub of the spindle motor 31 even when the second disk guide 81 and the guides 112 and 181 do not function.

Then, the link arm 105 and the discharge slider 106 move by the motion of the main slider 40, the discharge lever 100 is released from the locked state of the cam pin 107, and the movable side end of the discharge lever 100 turns toward the inserting port 11 by the elastic force of the elastic body 104. Therefore, the disk 1 released from the hub of the spindle motor 31 is pushed out toward the disk inserting opening 11 by the discharge lever 100. In the state where the discharge lever 100 moves, the pull-in lever 80 is held in a state where its movable side end moves in a direction where the movable side end is most separated from the spindle motor 31. The position of the pull-in lever 80 may be a position where the second disk guide 81 is not in contact with the disk 1. When a disk is to be discharged, if the pull-in lever 80 is disposed at a position where the disk 1 is not in abutment against the second disk guide 81, trouble caused when a disk is discharged can be prevented.

Next, a disk discharging operation without using the loading motor 60 will be explained.

As shown in FIG. 2, the rod-like body 200 is inserted from the opening 142 to mesh the temporary gear 202 with the gear 63. The main slider 40 connected through the worm gear cluster 62 is allowed to slide by rotating the rod-like body 200.

The motion of the main slider 40 at that time is the same as a normal ejecting motion. Therefore, the main slider 40 moves toward the disk inserting opening 11, the traverse 30 is displaced by the traverse moving means, the holding state of the disk by the spindle motor is released by the displacement of the traverse 30 and then, the discharge lever 100 is moved.

That is, the main slider 40 moves toward the disk inserting opening 11 by the rotation operation of the rod-like body 200. In the main slider 40, the cam pin 36 moves from the position of the cam pin 36C to the position of the cam pin 36A through the position of the cam pin 36B. In the sub-slider 50, the cam pin 37 moves from the position of the cam pin 37C to the position of the cam pin 37A through the position of the cam pin 37B, and the cam pin 53 moves from the position of the cam pin 53C to the position of the cam pin 53A through the position of the cam pin 53B. The disk 1 once moves toward the lid 130 by moving the cam mechanisms and then, the disk 1 moves toward the base body 10.

When the disk 1 moves toward the base body 10, the disk 1 abuts against the second disk guide 81, the guides 181 and 112 on the side of the outer periphery of the disk 1, and abuts against the pin 18 on the side of the inner periphery of the disk 1. Therefore, as the traverse 30 moves toward the base body 10, a force acting toward the lid 130 is applied to the disk 1 from the second disk guide 81, the guides 101 and 112 and the pin 18, and the disk 1 is released from the hub of the spindle motor 31. If the pin 18 is provided at the position of the outer periphery of the spindle motor 31 and further from the insulator 34 than the spindle motor 31 as in this embodiment, the disk 1 can be released from the hub of the spindle motor 31 even when the second disk guide 81 and the guides 112 and 181 do not function.

Then, the link arm 105 and the discharge slider 106 move by the motion of the main slider 40, the locked state of the cam pin 107 is released, and the movable side end of the discharge lever 100 turns toward the inserting port 11 by the elastic force of the elastic body 104. Therefore, the disk 1 released from the hub of the spindle motor 31 is pushed out toward the disk inserting opening 11 by the discharge lever 100. In the state where the discharge lever 100 moves, the pull-in lever 80 is held in a state where its movable side end moves in a direction where the movable side end is most separated from the spindle motor 31.

### Second Embodiment

A disk apparatus of another embodiment of the present invention will be explained below.

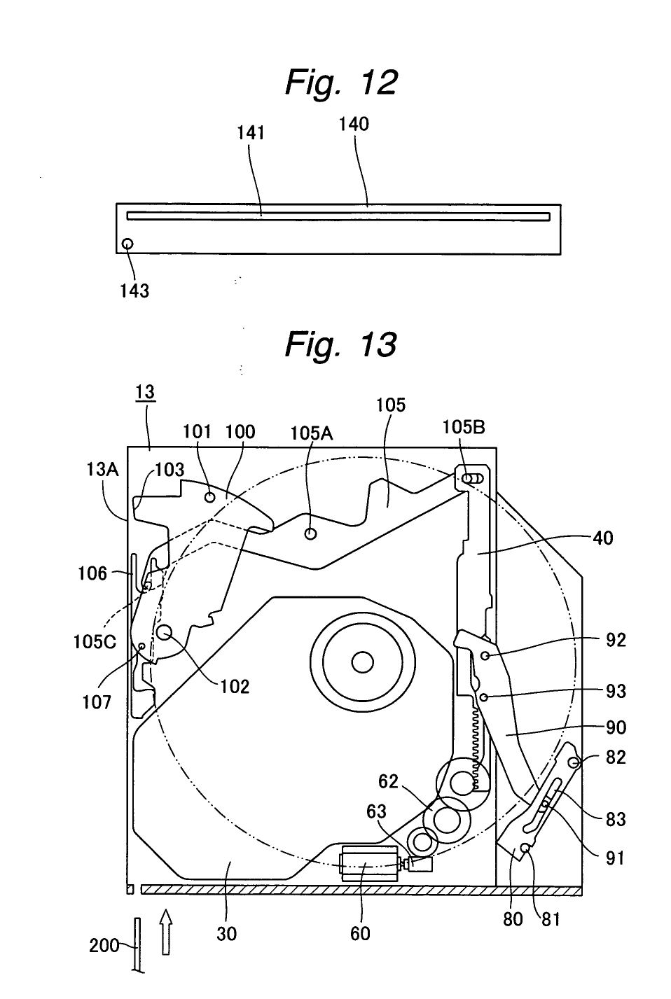

FIG. 12 is a front view of a front surface of a chassis outer sheath of a disk apparatus according to another embodiment of the invention. FIGS. 13 to 15 are plan views of essential portions of different states of a base body of the disk apparatus of the embodiment.

Structures having the same functions as those of the first embodiment are designated with the same symbols, and explanation thereof will be omitted.

In the disk apparatus, as shown in FIG. 12, an opening 143 is formed in the bezel 140 of a front surface of the chassis outer sheath. The rod-like body 200 can be inserted into the opening 143. The discharge slider 106 moves if the rod-like body 200 is inserted from the opening 143. That is, an operating direction of the rod-like body 200 from the opening 143 and an operating direction at the time of discharging operation of the discharge slider 106 match with each other.

The discharging motion of a disk by the discharge lever 100 when the loading motor 60 is not operated will be explained below.

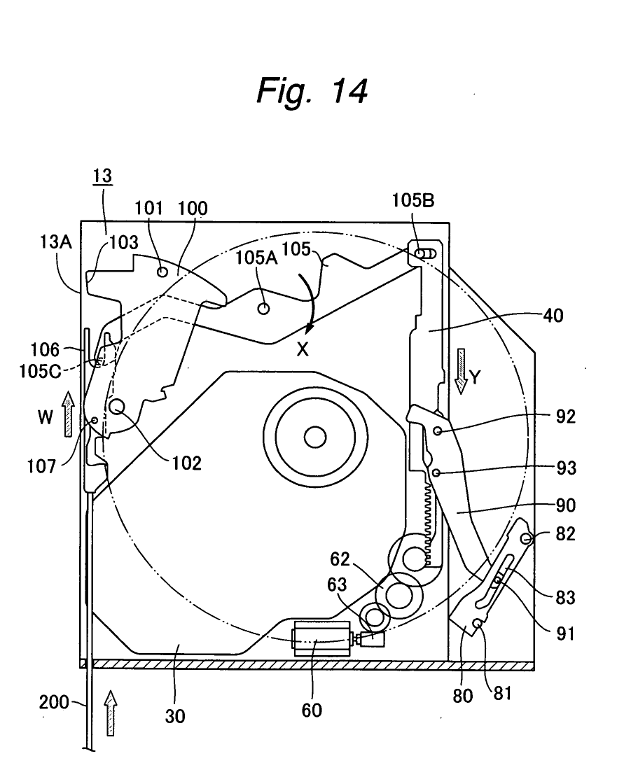

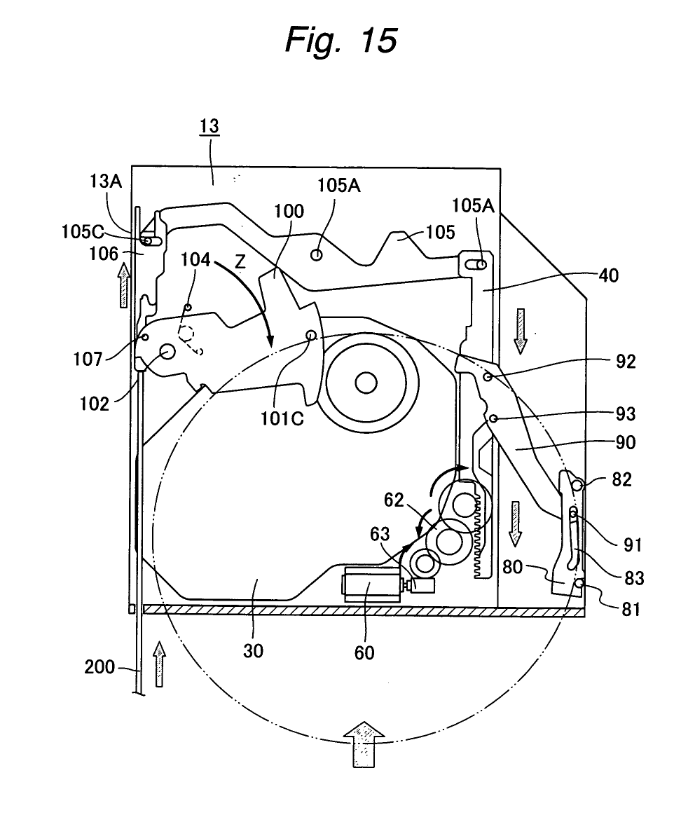

If the discharge slider 106 is moved in the direction of arrow W by the rod-like body 200, the link arm 105 connected to the discharge slider 106 rotates and moves in the direction of arrow X in FIG. 14, the main slider 40 connected to the link arm 105 through the pin 105B slides in the direction of arrow Y (longitudinal direction), and the traverse 30 is moved by the cam mechanism provided in the main slider 40. As shown in FIG. 15, the cam pin 107 of the discharge lever 100 is moved by the motion of the discharge slider 106 and then, the discharge lever 100 is turned in the direction of arrow Z by the spring elasticity of the elastic body 104. As the discharge lever 100 is turned in the direction of arrow Z, the discharging operation is carried out as shown in the first embodiment, and a disk can be discharged by the discharge lever 100 also when the loading motor 60 is not operated.

In this embodiment, a discharging driving mechanism which moves the discharge lever 100 when the loading motor 60 is not operated is constituted by the operation from the opening 143 by the rod-like body 200.

That is, according to the discharging driving mechanism in the embodiment, the opening 143 is formed in the front surface, the rod-like body 200 can be inserted into the opening 143, the discharge slider 106 is disposed at a position opposed to the opening 143, and the operation direction W of the rod-like body 200 from the opening 143 and the operation direction at the time of the discharging operation of the discharge slider 106 match with each other. In order to make it possible to slide the discharge slider 106 also by the operation of the rod-like body 200, an intersecting angle between the gear 63 and the worm gear cluster 62 is adjusted if necessary, the angle between the gear 63 and the worm gear cluster 62 inner surface set to helix angle. With this structure, the discharge slider 106 can be moved also by the operation of the rod-like body 200.

With this, even when the loading motor 60 stops abnormally, a disk can be unloaded using this discharging driving mechanism, and it is possible to easily cope with trouble.

### Third Embodiment

A disk apparatus of another embodiment of the present invention will be explained below.

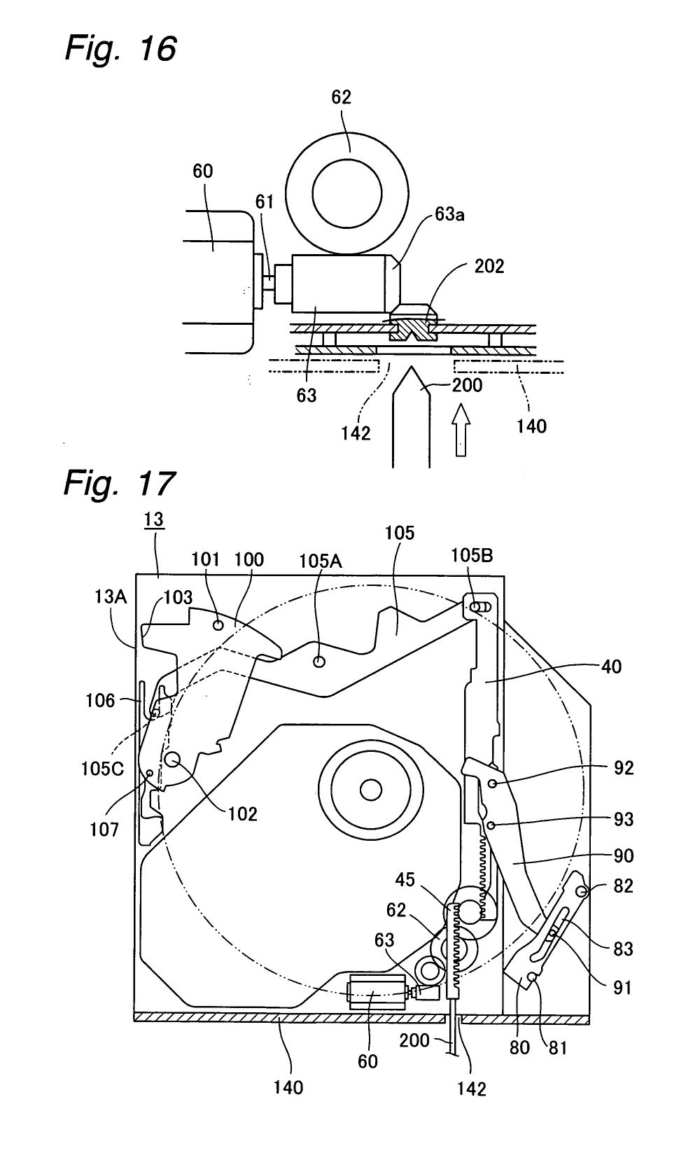

FIG. 16 is a plan view of an essential portion of the disk apparatus. Structures of this embodiment are the same as those of the first embodiment except a structure shown in FIG. 16, explanation of motions of the same structures as those of the first embodiment will be omitted.

A gear 63 is provided on a drive shaft 61 of the loading motor 60, and the worm gear cluster 62 mesh the gear 63. A bevel gear 63a is formed on a tip end of the gear 63 which meshes the worm gear cluster 62. The front surface of the chassis outer sheath or the bezel 140 is formed with the opening 142 into which the rod-like body 200 can be inserted.

In this embodiment, the temporary gear 202 previously meshes the bevel gear 63a. The gear 63 and the worm gear cluster 62 can be rotated by turning the rod-like body 200.

A body of the loading motor 60 is disposed on a central portion of the disk inserting opening 11, and the drive shaft 61 is disposed on the side of an end of the disk inserting opening 11.

### Fourth Embodiment

Next, a disk apparatus according to another embodiment of the invention will be explained.

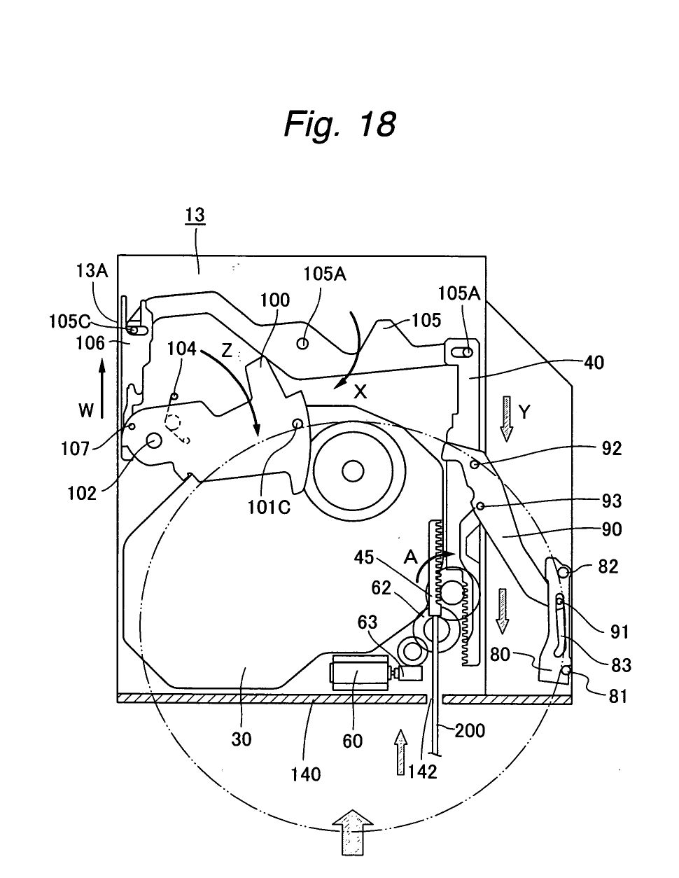

FIG. 17 is a plan view of an essential portion of a base body of the disk apparatus according to the other embodiment. FIG. 18 is a plan view of an essential portion of another state of the base body of the disk apparatus of the embodiment.

Structures having the same functions as those of the above embodiment are designated with the same symbols, and explanation thereof will be omitted.

In this disk apparatus also, the opening 142 is formed in the bezel 140 of the front surface of the chassis outer sheath, and the rod-like body 200 can be inserted into the opening 142. A temporary slider 45 is disposed at a position opposed to the opening 142, the temporary slider 45 engages the worm gear cluster 62, and the slider 40 slides by the sliding of the temporary slider 45. The operation direction of the rod-like body 200 from the opening 142 and the operation direction of the temporary slider 45 match with each other.

The discharging operation of a disk by the discharge lever 100 when the loading motor 60 is not operated will be explained below.

If the temporary slider 45 is moved by the rod-like body 200, the worm gear cluster 62 which engages the temporary slider 45 rotates in the direction of arrow A, the slider 40 slides in the direction of arrow Y (longitudinal direction), and the traverse 30 moves by the cam mechanism provided on the slider 40. The slider 40 slides in the direction of arrow Y (longitudinal direction) and with this, the link arm 105 connected to the slider 40 rotates and moves in the direction of arrow X, and the discharge slider 106 moves in the direction of arrow W. The cam pin 107 of the discharge lever 100 is moved by the movement of the discharge slider 106 in the direction of arrow W and then, the discharge lever 100 is turned in the direction of arrow Z by the spring elasticity of the elastic body 104. As the discharge lever 100 turns in the direction of arrow Z, the disk is discharged in the same manner as that of the above embodiment, and the disk can be discharged by the discharge lever 100 also when the loading motor 60 is not operated.

According to the embodiment, the discharging driving mechanism which moves the discharge lever 100 when the loading motor 60 is not operated is constituted by the operation of the rod-like body 200 from the opening 142.

That is, in the discharging driving mechanism of the embodiment, the temporary slider 45 is disposed at the position opposed to the opening 142 into which the rod-like body 200 provided on the front surface can be inserted, and the operation direction of the rod-like body 200 from the opening 142 and the operation direction at the time of the discharging operation of the temporary slider 45 match with each other.

According to the embodiment, the slider 40 can be moved by the temporary slider 45, the discharge lever 100 can be moved by the pushing operation of the temporary slider 45 and thus, the discharging operation can easily be carried out.

It is preferable that the disk apparatus of each of the second and fourth embodiments has connection-releasing means which releases connection between the loading motor 60 and the slider 40. According to the connection-releasing means (not shown), the loading motor 60 is inclined, or the loading motor 60 is evacuated in a direction away from the worm gear cluster 62, thereby releasing the connection between the gear 63 and the worm gear cluster 62. By providing the connection-releasing means, the connection between the loading motor 60 and the slider 40 can be released prior to operation of the rod-like body 200, and the discharging operation can easily be carried out.

According to the present invention, the disk apparatus can be reduced in thickness and size, and even when a loading motor is abnormally stopped, a disk can be unloaded, and it is possible to cope with trouble.

### INDUSTRIAL APPLICABILITY

According to the present invention, a disk apparatus can be reduced in thickness and size by the disposition structures of a printed substrate and a traverse, and even when a loading motor is abnormally stopped, a disk can be unloaded with a simple operation and it is possible to cope with trouble. Therefore, the invention is effective for a disk apparatus which is incorporated in or integrally set in a so-called notebook personal computer which is integrally provided with display means, input means, processing means and the like.

1. A disk apparatus comprising a chassis outer sheath having a base body and a lid, in which a front surface of said chassis outer sheath is formed with a disk inserting opening into which a disk is directly inserted, a connector is disposed on a rear surface of said chassis outer sheath, said base body is provided with a traverse and a printed substrate, said traverse holds a spindle motor, a pickup and drive means for moving said pickup, said traverse is disposed on the side of said disk inserting opening, and said printed substrate is disposed on the side of said connector,
the disk apparatus includes traverse moving means for displacing said traverse such that said spindle motor supported by said traverse can move between said base body side and said lid side,
said traverse moving means comprises a loading motor provided near a front surface of said chassis outer sheath, a slider which is connected to a drive shaft of said loading motor through a gear group and which slides in a longitudinal direction by driving force of said loading motor, and a cam mechanism provided on said slider,
said base body is provided with a discharge lever which pushes out a disk inserted on said traverse toward said disk inserting opening, and the disk apparatus includes a discharging driving mechanism which moves said discharge lever by motion of said slider caused by driving force of said loading motor, wherein
an opening into which a rod-like body can be inserted is formed in the front surface of said chassis outer sheath,
a temporary gear is provided at a position opposed to said opening,
said temporary gear and said gear group are connected to each other, and said discharge lever is moved by operation of said rod-like body.

2. The disk apparatus according to claim 1, wherein said temporary gear is held by an elastic member, and said elastic member is deformed by a pressing operation by said rod-like body against said temporary gear, thereby connecting said temporary gear and said gear group to each other.

3. The disk apparatus according to claim 1, wherein a gear connected to the drive shaft of said loading motor is formed with a bevel gear, and said temporary gear is connected to said bevel gear.

4. The disk apparatus according to claim 3, wherein said temporary gear and said bevel gear are previously connected to each other.

5. A disk apparatus comprising a chassis outer sheath having a base body and a lid, in which a front surface of said chassis outer sheath is formed with a disk inserting opening into which a disk is directly inserted, a connector is disposed on a rear surface of said chassis outer sheath, said base body is provided with a traverse and a printed substrate, said traverse holds a spindle motor, a pickup and drive means for moving said pickup, said traverse is disposed on the side of said disk inserting opening, and said printed substrate is disposed on the side of said connector,
the disk apparatus includes traverse moving means for displacing said traverse such that said spindle motor supported by said traverse can move between said base body and said lid,
said traverse moving means comprises a loading motor provided near a front surface of said chassis outer sheath, a slider which is connected to a drive shaft of said loading motor through a gear group and which slides in a longitudinal direction by driving force of said loading motor, and a cam mechanism provided on said slider,
said base body is provided with a discharge lever which pushes out a disk inserted on said traverse toward said disk inserting opening, and the disk apparatus includes a discharging driving mechanism which moves said discharge lever by motion of said slider caused by driving force of said loading motor, wherein
an opening into which a rod-like body can be inserted is formed in the front surface of said chassis outer sheath,
said slider or said discharge slider is allowed to slide by operation of said rod-like body from said opening, and said discharge lever is moved without a driving force from said loading motor.

6. The disk apparatus according to claim 5, wherein said discharge slider is disposed at a position opposed to said opening, and an operation direction of said rod-like body from said opening and an operation direction at the time of discharging operation of said discharging slider match with each other.

7. The disk apparatus according to claim 5, wherein a temporary slider is disposed at a position opposed to said opening, said slider slides by sliding motion of said temporary slider, an operation direction of said rod-like body from said opening and an operation direction of said temporary slider match with each other, and said temporary slider is allowed to slide by operation of said rod-like body.

8. The disk apparatus according to claim 5, further comprising connection-releasing means which releases connection between said loading motor and said slider.

9. The disk apparatus according to claim 1, wherein said traverse is displaced by said traverse moving means before said discharge lever is moved, and a held state of said disk to said spindle motor is released by the displacement of said traverse.

10. The disk apparatus according to claim 5, wherein said traverse is displaced by said traverse moving means before said discharge lever is moved, and a held state of said disk to said spindle motor is released by the displacement of said traverse.
